(19) United States
(12) Patent Application Publication
(10) Pub. No.: US 2023/0318008 A1
(43) Pub. Date: Oct. 5, 2023

(54) ELECTRODE BODY LAMINATION DEVICE AND ELECTRODE BODY PRODUCTION LINE

(71) Applicant: HONDA MOTOR CO., LTD., Tokyo (JP)

(72) Inventors: Shota ISHIKAWA, Saitama (JP); Michimasa TABUCHI, Saitama (JP); Yohei NOJI, Saitama (JP); Takashi TOYOSHIMA, Saitama (JP)

(73) Assignee: HONDA MOTOR CO., LTD., Tokyo (JP)

(21) Appl. No.: 18/122,347

(22) Filed: Mar. 16, 2023

(30) Foreign Application Priority Data
Mar. 29, 2022 (JP) 2022-054049

(51) Int. Cl. H01M 10/04; B32B 37/00

(52) U.S. Cl. CPC H01M 10/0404; B32B 37/0046; B32B 2309/14; B32B 2457/10

(57) ABSTRACT

A lamination device is disposed downstream of a conveying device configured to convey a plurality of electrode bodies, and laminates the plurality of electrode bodies. The lamination device includes: a mounting plate on which the plurality of electrode bodies are laminated, the mounting plate being inclined with respect to the electrode bodies being conveyed by the conveying device; a first wall erected on the mounting plate and perpendicular to a conveying direction; and a drop prevention portion provided on the first wall or on a wall different from the first wall, the drop prevention portion preventing the plurality of electrode bodies from dropping from the mounting plate.

### CROSS-REFERENCE TO RELATED APPLICATIONS

This application is based on and claims priority under 35 USC 119 from Japanese Patent Application No. 2022-054049 filed on Mar. 29, 2022, the contents of which are incorporated herein by reference.

### TECHNICAL FIELD

The present disclosure relates to an electrode body lamination device and an electrode body production line.

### BACKGROUND

In recent years, researches and development on secondary batteries that contribute to energy efficiency have been carried out to ensure access to convenient, reliable, sustainable, and advanced energy for more people.

A laminated cell and a square cell of a laminate type used as a secondary battery have a structure in which a plurality of electrode bodies are laminated and accommodated in a laminate film or a cell can. Therefore, the process of manufacturing these battery cells includes a process of laminating a plurality of electrode bodies.

For example, International Publication No. WO2013/125219 (hereinafter, referred to as Patent Literature 1) discloses a technique of laminating a positive electrode sheet, a negative electrode sheet, a separator, and the like by an operation of a turning unit having an arm.

However, in the related art disclosed in Patent Literature 1, the arm grips and laminates one by one, which may take time to complete the lamination, and there is room for improvement.

The present disclosure provides a lamination device and a production line that shorten the time required for laminating a plurality of electrode bodies.

Further, the present disclosure contributes to the efficiency of energy.

### SUMMARY

A first aspect of the present disclosure relates to a lamination device. The lamination device is disposed downstream of a conveying device configured to convey a plurality of electrode bodies, and laminates the plurality of electrode bodies. The lamination device includes: a mounting plate on which the plurality of electrode bodies are laminated, the mounting plate being inclined with respect to the electrode bodies being conveyed by the conveying device; a first wall erected on the mounting plate and perpendicular to a conveying direction; and a drop prevention portion provided on the first wall or on a wall different from the first wall, the drop prevention portion preventing the plurality of electrode bodies from dropping from the mounting plate.

A second aspect of the present disclosure relates to an electrode body production line for conveying and laminating a plurality of electrode bodies. The production line includes: a conveying device configured to convey the plurality of electrode bodies. A plurality of lamination devices each of which is the lamination device described above are provided. When a predetermined number of the electrode bodies are laminated on one of the lamination devices, the electrode body production line laminates the electrode bodies on another of the lamination devices.

According to the present disclosure, it is possible to shorten the time required for laminating a plurality of electrode bodies.

### BRIEF DESCRIPTION OF DRAWINGS

Exemplary embodiment(s) of the present invention will be described in detail based on the following figures, wherein:

FIG. 1 is a schematic diagram of a production line 100 for electrode bodies 30 of a first embodiment;

FIG. 2 is a perspective view of a stocker 1;

FIG. 3 is a top view of the vicinity of an opening 14 of the stocker 1;

FIG. 4 is a diagram illustrating a laminated cell 40;

FIG. 5 is a cross-sectional view of the stocker 1 provided with a speed reduction mechanism 15 and a buffer member 16;

FIG. 6 is a diagram illustrating a part of a production line 100 for the electrode bodies 30 according to a first modification; and

FIG. 7 is a diagram illustrating a part of a production line 100 for the electrode bodies 30 according to a second modification.

### DESCRIPTION OF EMBODIMENTS

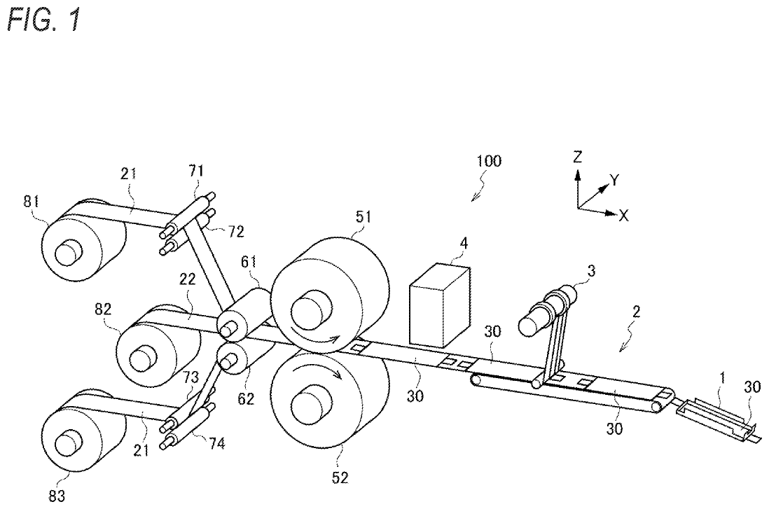

FIG. 1 is a schematic diagram of a production line 100 for electrode bodies 30. The production line 100 of the present embodiment includes a conveying device 2 that conveys the plurality of electrode bodies 30, and a stocker 1 that is disposed downstream of the conveying device 2 and laminates the plurality of electrode bodies 30. The conveying device 2 is provided with electrode rolls 81 and 83 around which a negative electrode member 21 is wound and an electrode roll 82 around which a positive electrode member 22 is wound. The positive electrode member 22 includes a current collector foil and a positive-electrode active material applied to the current collector foil. The negative electrode member 21 includes a current collector foil and a negative-electrode active material applied to the current collector foil. A battery cell of the present embodiment is a solid-state battery, in which the positive electrode member 22 (positive electrode layer) is disposed between a pair of the negative electrode members 21 (negative electrode layers). A solid electrolyte layer is disposed between the positive electrode member (positive electrode layer) and each of the negative electrode members (negative electrode layers). In the production line 100 of FIG. 1, the solid electrolyte layer may be provided on both surfaces of the positive electrode member 22, and may be provided on one surface of each negative electrode member 21. In the present specification, the structure in which the positive electrode member 22 is disposed between the negative electrode members 21 is referred to as an electrode body 30.

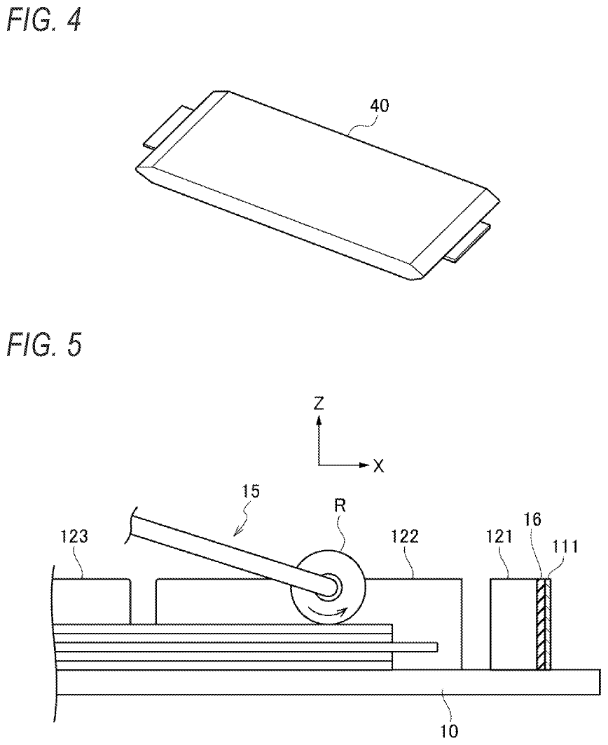

In a subsequent step, a plurality of electrode bodies 30 are covered with a laminate film in a state where tab leads are joined to the current collector foils of the positive electrode and the negative electrodes, and the tab leads are exposed. FIG. 4 illustrates a laminated cell using the electrode body 30 manufactured in the production line 100 of FIG. 1.

Returning to FIG. 1, the conveying direction of the electrode body 30 of the present embodiment coincides with the long-axis direction of the electrode body 30. The electrode member 21 of the negative electrode roll 81 is guided by roll devices 71 and 72, and is overlapped with the other electrode members by the roll devices 61 and 62. The positive electrode roll 82 is guided by the roll devices 61 and 62, and is overlapped with the other electrode members. The electrode member 21 of the negative electrode roll 83 is guided by roll devices 73 and 74, and is overlapped with the other electrode members by the roll devices 61 and 62.

The three electrode members overlapped by the roll devices 61 and 62 are integrated by receiving pressure from above and below by roll presses 51 and 52. Next, a laser cutter 4 installed above the conveyance path emits a laser to make a cut in the end material of the outer peripheral portion of the integrated electrode body 30. For example, when the electrode body 30 is conveyed to the conveying device 2 which is a belt conveyor, the cut end material is wound by an end material winding device 3.

The conveying device 2 conveys the electrode body 30 at a predetermined speed (for example, 100 meters per second). The electrode body 30 conveyed to the end of the conveying device 2 is ejected from the conveying device 2 by inertia and drops onto the stocker 1. In the stocker 1, the electrode bodies 30 sent from the conveying device 2 are laminated in order. The stocker 1 is disposed downstream of the conveying device 2 at a position close to the conveying device 2 (that is, a position that allows the reception of the electrode body 30 sent from the conveying device 2).

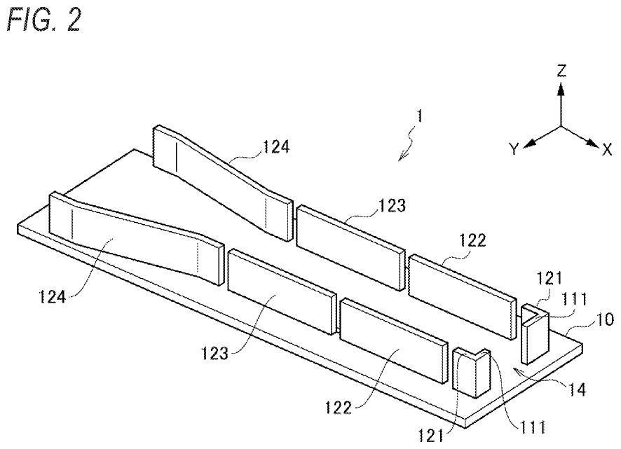

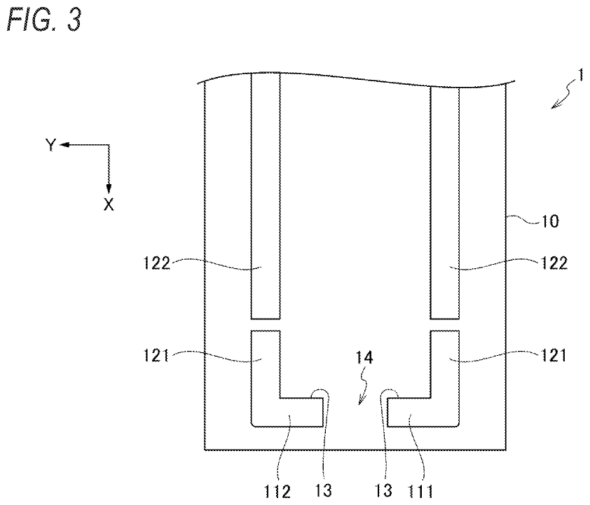

FIG. 2 is a diagram illustrating the stocker 1, and FIG. 3 is a top view of the vicinity of an opening 14 of the stocker 1. The stocker 1 includes a mounting plate 10 on which the plurality of electrode bodies 30 are laminated. The mounting plate 10 is provided with a first wall 111 perpendicular to the conveying direction and a pair of guide walls 121 to 124 facing each other with the conveyance path interposed therebetween, thereby aligning the plurality of laminated electrode bodies 30 (that is, eliminating deviation when viewed in the lamination direction). The guide walls 121 to 124 may be integrated with each other on each side.

More specifically, the first wall 111 includes a drop prevention portion 13 for preventing the electrode bodies 30 from dropping from the mounting plate 10. The drop prevention portion 13 is a surface facing the conveying device 2 in the X-axis direction, which is the conveying direction of the electrode bodies 30. The first wall 111 is provided with the opening 14 (see FIG. 3) at the center of the drop prevention portion 13 in the Y-axis direction. In the Y-axis direction perpendicular to the conveying direction, the width of the opening 14 is larger than the width of the current collector foils extending from the electrode bodies 30. Therefore, the current collector foils are accommodated in the opening 14 even when the electrode bodies 30 reach the first wall 111 (that is, the drop prevention portion 13), and thus the first wall 111 does not interfere with the current collector foils.

The guide walls 121 to 124 face each other in the Y-axis direction, which is a direction perpendicular to the conveying direction. The distance in the Y-axis direction between the guide walls 121 to 123 facing each other is slightly larger than the electrode bodies 30 and is constant. On the other hand, the distance between the guide walls 124 in the Y-axis direction decreases toward the first wall 111 in the conveying direction. Therefore, when the electrode bodies 30 pass between the guide walls 124, the deviation in the Y-axis direction is corrected.

The mounting plate 10 of the stocker 1 is inclined downward from the upstream side toward the downstream side in the conveying direction. Therefore, the electrode bodies conveyed to the stocker 1 move downward toward the first wall 111, abut against the first wall 111 (drop prevention portion 13), and stop. As a result, the plurality of electrode bodies continuously conveyed from the conveying device 2 are laminated in contact with the first wall 111 (drop prevention portion 13), and are aligned even without a mechanical mechanism or the like for alignment. The mounting plate 10 of the stocker 1 may be inclined such that one side of the guide walls 121 to 124 is positioned lower than the other side. In this way, the electrode bodies 30 are laminated in contact with the first wall 111 and the guide walls 121 to 123 on the lower side.

As described above, according to the stocker 1 of the present embodiment, the plurality of electrode bodies 30 can be laminated using the movement (for example, dropping) of the electrode bodies 30 themselves, which can shorten the time required until the completion of the lamination.

In addition, processes after the plurality of electrode bodies 30 are laminated include a process such as laminate processing. Since subsequent processes cannot be performed if the plurality of electrode bodies 30 are laminated with a deviation, it is important to align the plurality of electrode bodies 30 to eliminate deviation. In the stocker 1 of the present embodiment, the mounting plate 10 is inclined downward from the upstream side toward the downstream side in the conveying direction, and the electrode bodies 30 pass through the guide walls 121 to 124 facing each other and abut against the first wall 111 (drop prevention portion 13), which can improve the accuracy of lamination.

In addition, since the electrolyte layer of the present embodiment is not a liquid or a gel but a solid electrolyte layer, it is possible to reduce the possibility of damage to the electrode bodies 30 (for example, leakage of the electrolyte) when the electrode bodies 30 collide with the first wall 111.

In addition, since the current collector foils of the plurality of electrode bodies 30 laminated in the stocker 1 are accommodated in the opening 14, it is possible to prevent damage to the current collector foils. The opening 14 may be a recess.

As illustrated in FIG. 5, a speed reduction mechanism 15 may be provided to reduce an impact received when the electrode bodies 30 collide with either one of the first walls 111. FIG. 5 is a cross-sectional view of the stocker 1, and illustrates the electrode bodies 30 moving on the mounting plate 10. The speed reduction mechanism 15 has a roller R that comes into contact with the upper surface of the electrode bodies 30 by its own weight, and generates a frictional force between the roller R and the electrode bodies 30 when the electrode bodies 30 move on the mounting plate 10. This frictional force can reduce the movement speed of the electrode bodies 30. The roller R is, for example, an elastic member such as rubber, but the material thereof is not limited.

Further, as illustrated in FIG. 5, the first wall 111 may be provided with a buffer member 16 in the drop prevention portion 13. The buffer member 16 may be, for example, a air-bubble buffer member, a rubber plate, or the like. The electrode bodies 30 do not directly collide with the drop prevention portion 13 of the first wall 111, but collide with the buffer member 16, which can reduce the impact received upon the collision.

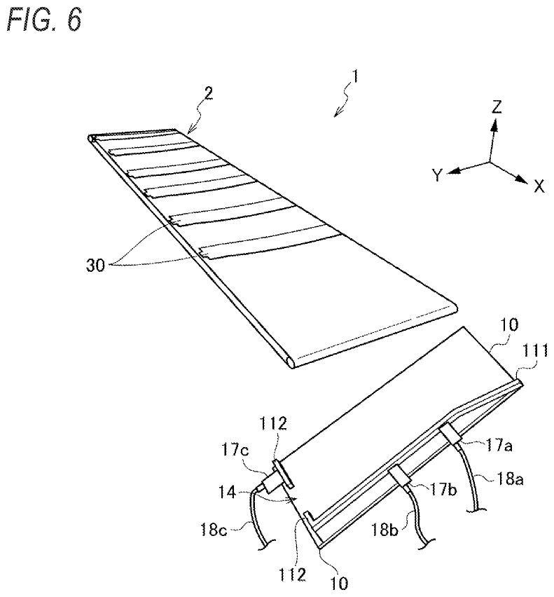

FIG. 6 is a diagram illustrating a part of a production line 100 according to a first modification of the present embodiment. In the first modification, the conveying direction and the short-axis direction of the electrode bodies 30 coincide with each other.

In the stocker 1 of the present modification, the mounting plate 10 is provided with the first wall 111 perpendicular to the conveying direction and a second wall 112 intersecting the first wall 111 and provided on the lower end side of the first wall 111, thereby aligning the plurality of laminated electrode bodies 30 (that is, eliminating deviation when viewed in the lamination direction). This modification is different from the above-described embodiment in the inclination direction of the mounting plate 10 and the wall provided with the drop prevention portion 13.

Specifically, the first wall 111 includes a surface facing the conveying device 2 in the X-axis direction, which is the conveying direction of the electrode bodies 30. The second wall 112 is perpendicular to the first wall 111, and includes the drop prevention portion 13 for preventing the electrode bodies 30 from dropping from the mounting plate 10. The second wall 112 is provided with the opening 14 at the center of the drop prevention portion 13 in the X-axis direction. The width of the opening 14 is larger than the width of the current collector foils extending from the electrode bodies 30. Therefore, the current collector foils are accommodated in the opening 14 even when the electrode bodies 30 reach the second wall 112 (that is, the drop prevention portion 13), and thus the second wall 112 does not interfere with the current collector foils.

The mounting plate 10 of the stocker 1 is inclined downward in a direction away from the conveying device in a perpendicular direction (Y-axis direction) perpendicular to the conveying direction 2. Namely, the mounting plate 10 of the stocker 1 is inclined in the Y-axis direction, and one end of the mounting plate 10 of the stocker 1 is at a position lower than the other end of the mounting plate 10 of the stocker 1. Therefore, the electrode bodies conveyed to the stocker 1 collide with the first wall 111 and then move downward toward the second wall 112, abut against the second wall 112 (drop prevention portion 13), and stop. As a result, the plurality of electrode bodies 30 continuously conveyed from the conveying device 2 are laminated in contact with the second wall 112 (drop prevention portion 13), and are aligned even without a mechanical mechanism or the like for alignment. The mounting plate 10 of the stocker 1 may be inclined such that the side closer to the first wall 111 is positioned on the lower side. Thereby, the electrode bodies 30 are laminated in contact with the first wall 111 and the second wall 112. In addition, the first wall 111 may be provided with a buffer member 16 on a surface to collide with the electrode bodies 30. The second wall 112 may be provided with the buffer member 16 on a surface of the drop prevention portion 13 to collide with the electrode body 30.

The stocker 1 is provided with vibration devices 17a, 17b, and 17c. The vibration devices 17a and 17b are attached to the first wall 111, and vibrate the mounting plate 10 via the first wall 111 by gas supplied from air hoses 18a and 18b. The vibration device 17c is attached to the second wall 112, and vibrates the mounting plate 10 via the second wall 112 by gas supplied from an air hose 18c.

As described above, according to the stocker 1 of the first modification, the lamination can be performed using the movement of the electrode bodies 30 themselves (for example, dropping), which can shorten the time required until the completion of the lamination.

Since the electrode bodies 30 are conveyed in the short-axis direction, the electrode bodies 30 are less likely to wrinkle when being pressed by the roll presses 51 and 52.

Since the mounting plate 10 is vibrated by the vibration devices 17a, 17b, and 17c, the plurality of electrode bodies 30 are easily collected at a desired position on the mounting plate 10, which improves the accuracy of lamination. The vibration devices 17a, 17b, and 17c may be attached to the mounting plate 10.

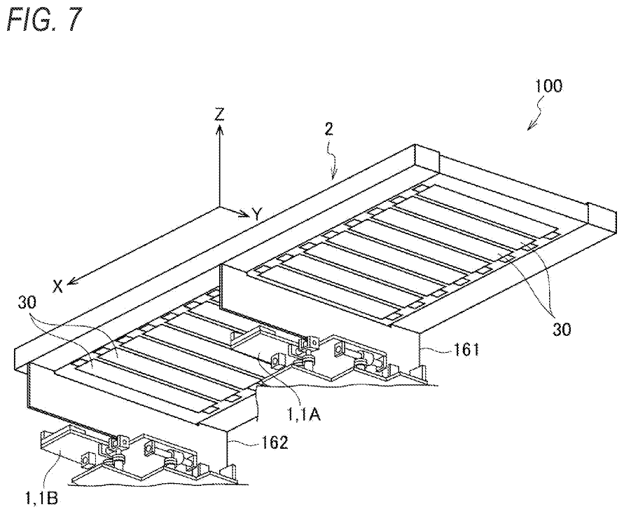

FIG. 7 is a diagram illustrating a production line 100 for the electrode bodies 30 according to a second modification of the present embodiment. In the production line 100 of the electrode body 30 of the second modification, the conveying device 2 is installed such that the conveyance surface faces downward in the vertical direction (Z-axis direction). The conveying device 2 is, for example, suspended from the ceiling, and the electrode bodies 30 are conveyed in the X-axis direction while being suctioned by air or being gripped by a mechanical mechanism or the like.

Two stockers 1 are installed below the conveying device 2. Hereinafter, a stocker on the upstream side is referred to as 1A, and a stocker on the downstream side is referred to as 1B. The stockers 1A and 1B are the same as the stocker 1 illustrated in FIG. 6. The conveying device 2 of the present modification is provided with trajectory-adjusting plates 161 and 162. The trajectory-adjusting plates 161 and 162 restrict the movement of the electrode bodies 30 from dropping on a place other than the stockers 1A and 1B.

When a predetermined number of the electrode bodies 30 are laminated on the stocker 1A, the production line 100 for the electrode bodies 30 subsequently laminates the electrode bodies 30 on the stocker 1B. Specifically, when the electrode bodies 30 that reach the upper side of the stocker 1A are sent to the stocker 1A and reach the predetermined number, the electrode bodies 30 that reach the upper side of the stocker 1A are not sent to the stocker 1A, but are conveyed to the upper side of the stocker 1B and sent to the stocker 1B. Then, the predetermined number of the electrode bodies 30 are laminated on the stocker 1B. In the meantime, the plurality of electrode bodies 30 laminated on the stocker 1A are taken away, and when the number of electrode bodies 30 on the stocker 1B reaches the predetermined number, the electrode bodies 30 are laminated on the stocker 1A again.

As described above, the plurality of laminated electrode bodies 30 are to be subjected to laminate processing in a later step, and thus are moved to another place. When the time interval between lamination of the electrode bodies 30 is short, the next electrode bodies 30 may arrive while the step of moving the electrode bodies 30 is performed, leading to inappropriate lamination. According to the production line 100 for the electrode bodies as described above, since the electrode body 30 can be prevented from being continuously fed to the same stocker, the electrode bodies 30 can be laminated continuously, and the time required until the completion of the lamination can be shortened.

Although various embodiments have been described above with reference to the drawings, it is needless to say that the present disclosure is not limited to these examples. It is apparent to those skilled in the art that various changes and modifications can be conceived within the scope of the claims, and it is also understood that such changes and modifications naturally belong to the technical scope of the invention. In addition, constituent elements in the above embodiments may be freely combined without departing from the spirit of the invention.

At least the following matters are described in the present specification. Although the corresponding components or the like in the above-described embodiment are shown in parentheses, the present disclosure is not limited thereto.

(1) A lamination device (stocker 1) that is disposed downstream of a conveying device (conveying device 2) configured to convey a plurality of electrode bodies (electrode bodies 30), and laminates the plurality of electrode bodies, the lamination device including:

a mounting plate (mounting plate 10) on which the plurality of electrode bodies are laminated, the mounting plate being inclined with respect to the electrode bodies being conveyed by the conveying device;

a first wall (first wall 111) erected on the mounting plate and perpendicular to a conveying direction; and

a drop prevention portion (drop prevention portion 13) provided on the first wall or on a wall different from the first wall (second wall 112), the drop prevention portion preventing the plurality of electrode bodies from dropping from the mounting plate.

According to (1), the lamination can be performed using the movement of the conveyed electrode bodies per se, which can shorten the time required until the completion of the lamination. In addition, since the conveyed mounting plate abuts against the first wall, the first wall prevents the deviation. In addition, the drop prevention portion of the mounting plate can prevent dropping from the mounting plate.

(2) The lamination device according to (1), in which

the mounting plate is inclined downward from an upstream side toward a downstream side in the conveying direction,

the drop prevention portion is provided on the first wall,

the lamination device includes a pair of guide walls (guide walls 121 to 124) perpendicular to the first wall, and

the pair of guide walls have a region in which a distance between the pair of guide walls decreases toward the first wall in the conveying direction.

According to (2), it is possible to laminate the electrode bodies while conveying the electrode bodies in the conveying direction as they are.

(3) The lamination device according to (1), in which

the mounting plate is inclined downward in a direction perpendicular to the conveying direction with distance from the conveying device,

the lamination device further includes a second wall (second wall 112) intersecting the first wall and provided on a lower end side of the first wall, and

the drop prevention portion is provided on the second wall.

According to (3), it is possible to laminate the electrode bodies while conveying the electrode bodies in a direction perpendicular to the conveying direction.

(4) The lamination device according to any one of (1) to (3), in which

each of the plurality of electrode bodies is an electrode body in which at least a positive electrode layer, a solid electrolyte layer, and a negative electrode layer are laminated.

According to (4), since the electrode bodies include an electrolyte layer that is not a liquid or a gel but a solid electrolyte layer, it is possible to reduce the possibility of damage to the electrode bodies when the electrode bodies collide with the first wall.

(5) The lamination device according to any one of (1) to (4), in which

the first wall includes a buffer member (buffer member 16).

According to (5), it is possible to limit the impact when the electrode bodies collide with the first wall, which can limit damage to the electrode bodies.

(6) The lamination device according to any one of (1) to (5), further including:

a vibration device (vibration devices 17a to 17c) configured to apply vibration to the mounting plate.

According to (6), since the mounting plate can be vibrated, the position at which the plurality of electrode bodies are laminated can be set to a desired position, which can improve the accuracy of the lamination position.

(7) The lamination device according to any one of (1) to (6), in which

the drop prevention portion (opening 14) includes a current collector foil accommodating portion configured to accommodate current collector foils of the plurality of electrode bodies.

According to (7), damage to the current collector foils can be prevented.

(8) The lamination device according to any one of (1) to (7), further including:

a speed reduction mechanism 15 (speed reduction mechanism 15) facing the mounting plate and in contact with upper surfaces of the plurality of laminated electrode bodies to reduce a speed of the electrode bodies.

According to (8), it is possible to reduce the impact when the electrode bodies collide with the first wall.

(9) An electrode body production line (production line 100) for conveying and laminating a plurality of electrode bodies, the production line including:
a conveying device (conveying device 2) configured to convey the plurality of electrode bodies, in which

a plurality of lamination devices each of which is the lamination device according to any one of (1) to (8) are provided, and

when a predetermined number of the electrode bodies are laminated on one of the lamination devices, the electrode body production line laminates the electrode bodies on another of the lamination devices.

According to (9), it is possible to continuously laminate the electrode bodies, and it is possible to shorten the time required until the completion of the lamination.

1. A lamination device, wherein
the lamination device is disposed downstream of a conveying device configured to convey a plurality of electrode bodies, and laminates the plurality of electrode bodies, and
the lamination device comprises:
a mounting plate on which the plurality of electrode bodies are laminated, the mounting plate being inclined with respect to the electrode bodies being conveyed by the conveying device;
a first wall erected on the mounting plate and perpendicular to a conveying direction; and
a drop prevention portion provided on the first wall or on a wall different from the first wall, the drop prevention portion preventing the plurality of electrode bodies from dropping from the mounting plate.

2. The lamination device according to claim 1, wherein
the mounting plate is inclined downward from an upstream side toward a downstream side in the conveying direction,
the drop prevention portion is provided on the first wall,
the lamination device includes a pair of guide walls perpendicular to the first wall, and
the pair of guide walls have a region in which a distance between the pair of guide walls decreases toward the first wall in the conveying direction.

3. The lamination device according to claim 1, wherein
the mounting plate is inclined downward in a direction perpendicular to the conveying direction with distance from the conveying device,
the lamination device further includes a second wall intersecting the first wall and provided on a lower end side of the first wall, and
the drop prevention portion is provided on the second wall.

4. The lamination device according to claim 1, wherein
each of the plurality of electrode bodies is an electrode body in which at least a positive electrode layer, a solid electrolyte layer, and a negative electrode layer are laminated.

5. The lamination device according to claim 1, wherein
the first wall includes a buffer member.

6. The lamination device according to claim 1, further comprising:
a vibration device configured to apply vibration to the mounting plate.

7. The lamination device according to claim 1, wherein
the drop prevention portion includes a current collector foil accommodating portion configured to accommodate current collector foils of the plurality of electrode bodies.

8. The lamination device according to claim 1, further comprising:
a speed reduction mechanism 15 facing the mounting plate and in contact with upper surfaces of the plurality of laminated electrode bodies to reduce a speed of the electrode bodies.

9. An electrode body production line for conveying and laminating a plurality of electrode bodies, the production line comprising:
a conveying device configured to convey the plurality of electrode bodies, wherein
a plurality of lamination devices each of which is the lamination device according to claim 1 are provided, and
when a predetermined number of the electrode bodies are laminated on one of the lamination devices, the electrode body production line laminates the electrode bodies on another of the lamination devices.
